(19) United States
(12) Patent Application Publication
(10) Pub. No.: US 2014/0204775 A1
(43) Pub. Date: Jul. 24, 2014

(54) ROUTE SELECTION METHOD FOR USE WHERE PLURAL HETEROGENEOUS NETWORKS ARE AVAILABLE

(71) Applicant: D-LINK CORPORATION, Taipei City (TW)

(72) Inventors: Jun-Hao HUANG, Taipei City, (TW); Wei-Chung HSU, Taipei City, (TW); Ming-Han LIU, Taipei City, (TW)

(73) Assignee: D-LINK CORPORATION, Taipei City, (TW)

(21) Appl. No.: 13/798,501

(22) Filed: Mar. 13, 2013

(30) Foreign Application Priority Data
Jan. 18, 2013 (TW) 102101918

(51) Int. Cl. H04L 12/56

(52) U.S. Cl. CPC H04L 45/14
USPC 370/252

(57) ABSTRACT

The present invention is to provide a route selection method which is applicable to a network connection device capable of receiving or transmitting a network packet through at least two heterogeneous networks. Upon receiving the packet, the device performs route performance detection to obtain the current transmission delay rate of each of the heterogeneous networks, and then determines whether the packet is highly sensitive to transmission delay or has a re-transmission mechanism. When it is determined that the packet is highly sensitive to transmission delay or doesn't have the re-transmission mechanism, the device chooses from the plural heterogeneous networks the one with a relatively low transmission delay rate as the route through which to transmit the packet to the Internet; otherwise, the device chooses from the plural heterogeneous networks the one with a relatively high transmission delay rate as the route through which to transmit the packet to the Internet.

### FIELD OF THE INVENTION

The present invention relates to a route selection method, more particularly to a route selection method applicable to a network connection device capable of receiving or transmitting a network packet through at least two heterogeneous networks (e.g., a power-line network, a Wi-Fi network, a Multimedia over Coax Alliance (MoCA) network, and an Ethernet), performing route performance detection to obtain the current transmission delay rate of each of the heterogeneous networks when receiving the packet, and determining whether the packet is highly sensitive to transmission delay or has a re-transmission mechanism. When it is determined that the packet is highly sensitive to transmission delay or doesn't have the re-transmission mechanism, the device chooses from the plural heterogeneous networks the one with a relatively low transmission delay rate as the route through which to transmit the packet to the Internet, otherwise, chooses the one with a relatively high transmission delay rate as the route through which to transmit the packet, so as to effectively prevent ordinary Data or Background network packets from occupying those heterogeneous networks with relatively high transmission quality.

### BACKGROUND OF THE INVENTION

With the rapid development of Internet-based applications such as the World Wide Web (WWW), electronic mails (e-mails), the File Transfer Protocol (FTP), the Bulletin Board System (BBS), and remote terminal emulation (Telnet), people nowadays rely heavily on the use of networks to get work done, make friends, and cultivate interests. To satisfy the need to connect to a network wherever possible (e.g., at a train station, in an office, and at home), a variety of wired or wireless network structures have been designed and put into use, including Wi-Fi networks, power-line networks, and Ethernets, to name only a few. These network structures provide the means whereby individuals and institutions can access the desired network services (e.g., distance education programs and international corporate conferences).

Today, the network technology for use by an electronic product is determined by the attributes of the product. Some common examples of such network technologies are Wi-Fi, power-line networking, coaxial-cable (coax) networking, and Ethernet. While it is generally desired that each electronic device in a digital family can access all sorts of network services, none of the aforementioned, network technologies or any other existing network technology is designed to support electronic products of all kinds. Hence, the idea of a hybrid home network was proposed and was championed by a good number of enterprises. Consequently, the IEEE 1905.1 standard for hybrid home networking emerged, which incorporates Wi-Fi, power-line networking, coax networking, and Ethernet. Products complying with the IEEE 1905.1 networking standard are now commercially available.

However, despite the feet that IEEE 1905.1 integrates Wi-Fi, power-line networking, coax networking, and Ethernet, the transmission properties of those network technologies remain the same. And because of that, each of the network technologies may still have relatively low transmission quality at a certain time point or in a certain environment. For example, when blocked, by a concrete wall or a human body, Wi-Fi signals tend, to attenuate fast, are subject to significant transmission delay, or even have dead, spots. When it comes to power-line networking, transmission speed may lower due to the phase(s) of the electric power and noises from other electric appliances. As for coax networking, its high throughput and high interference resistance can be only tantalizing, simply considering the limited distribution and. relatively high prices of coaxial cables. The greatest benefit of the IEEE 1905.1 networking standard is to achieve a higher transmission speed, a wider transmission range, and. higher network stability by combining the advantages of Wi-Fi, power-line networking, coax networking, and Ethernet.

However, according to the applicant's observation, IEEE 1905.1-compliant products are still flawed in terms of data transfer and fail to provide the highest transmission quality. Take a product supporting both Wi-Fi and power-line networking for example. Data transfer is typically carried out through power lines first. Only when the bandwidth of the power lines becomes insufficient will some of the data be transmitted through Wi-Fi. Nevertheless, when the quality of power-line transmission is lowered, by noises of other electric appliances and ends up inferior to the transmission quality of Wi-Fi, data will still be transmitted via the power lines if the power lines can provide a sufficient bandwidth. Should voice communication be carried out in this way, speech quality will be poor, causing unsatisfactory user experience. In addition, none of the existing products is configured to assess the attributes of network packets. As a result, a large number of packets which are not highly sensitive to transmission delay will still be transmitted via power lines first, thereby occupying the available bandwidth of the power lines, forcing packets which are highly sensitive to transmission delay to travel through Wi-Fi. The quality of a network service thus delivered will be compromised.

It can be known from the above that the transmission quality of any given network technology is not invariant but is subject to influences of the environment. Therefore, the issue to be addressed, by the present invention is to design a method for evaluating the current transmission performance of each of a plurality of available networks and for selecting the optimal transmission route for each type of packets.

### BRIEF SUMMARY OF THE INVENTION

In view of the fact that the transmission quality of any given network technology may fluctuate depending on the environment or on the network structure of each home or local area, the inventor of the present invention conducted extensive research and experiment and finally succeeded in developing a route selection method to be used where a plurality of heterogeneous networks are available. The present invention effectively solves the aforementioned problems and helps provide network users with better services.

It is an object of the present invention to provide a route selection method for use where a plurality of heterogeneous networks are available. The route selection method is applicable to a network connection device (e.g., a router, modem, or smart phone) capable of receiving or transmitting a network packet through at least two heterogeneous networks (e.g., a power-line network, a Wi-Fi network, a Multimedia over Coax Alliance (MoCA) network, and an Ethernet). Upon receiving the network packet, the network connection device performs route performance detection to obtain the current transmission delay rate of each of the heterogeneous networks. Then, based on the type (e.g., Data, Background, Video, VoIP, or Internet Management), transmission protocol (e.g., TCP or UDP), or packet source (e.g., YouTube, hulu, or youku) of the network packet, the network connection device determines whether the network packet is highly sensitive to transmission delay or whether the network packet has a re-transmission mechanism. When it is determined that the network packet is highly sensitive to transmission delay or does not have a re-transmission mechanism, the network connection device chooses from the plural heterogeneous networks the one with a relatively low transmission delay rate as the route through which to transmit the network packet to the Internet or an electronic device. When it is determined that the network packet is not highly sensitive to transmission delay or has a re-transmission mechanism, the network connection device chooses from the plural heterogeneous networks the one with a relatively high transmission delay rate as the route through which to transmit the network packet to the Internet or the electronic device. Thus, the route selection method of the present invention prevents ordinary Data or Background network packets from occupying those heterogeneous networks with relatively high transmission quality. Moreover, based, on the network structure of the country or local environment where the user is, the route selection method can select from the heterogeneous networks the optimal routes for transmitting network packets of different attributes respectively, thereby effectively increasing the transmission quality and efficiency of each network packet and creating a better user experience.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1 is a schematic structural diagram of an embodiment of the present invention; and

FIG. 2 is the flowchart of the present invention.

### DETAILED DESCRIPTION OF THE INVENTION

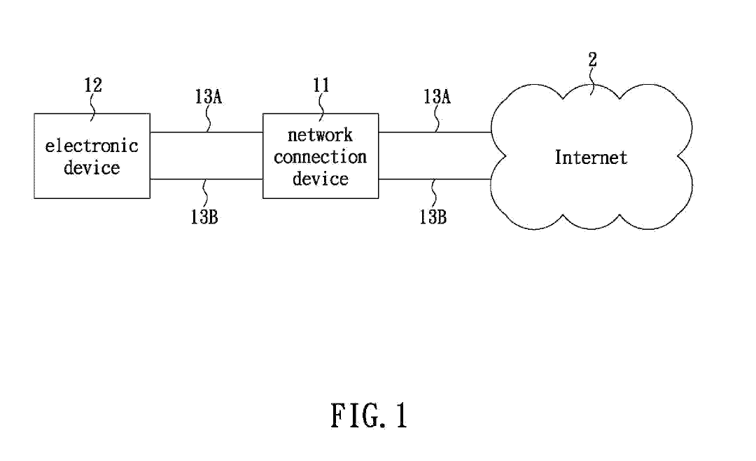

The present invention discloses a route selection method for use where a plurality of heterogeneous networks are available. In the embodiment shown in FIG. 1, the route selection method is applied to a network connection device 11, which may be a router, a modern, or the like. The network connection device 11 is connected to an electronic device 12 (e.g., a personal computer) through at least two heterogeneous networks. While only two heterogeneous networks are illustrated in FIG. 1, the network connection device 11 in another embodiment may use the four network technologies supported by the IEEE 1905.1 networking standard (i.e., power-line networking, wireless networking (Wi-Fi), coax networking, and Ethernet) at the same time if the network connection device 11 complies with this standard. Apart from the IEEE 1905.1 networking standard, it is also feasible for the route selection method of the present invention to use G.hn or other networking standards in which multiple network technologies are defined. Besides, the network connection device 11 in the present invention may be a smart phone or other devices having a network interface, provided that the network connection device is capable of using at least two network technologies. To facilitate subsequent description, the two heterogeneous networks to which the network connection device 11 is connected are respectively identified, as a power-line network 13A and a Wi-Fi network 13B, which networks can transmit network packets from the electronic device 12 to the Internet 2 or vice versa, so as for the electronic device 12 to access various network services in the Internet 2.

Referring to FIG. 1, the network connection device 11, upon receiving a network packet from the electronic device 12 or the Internet 2, performs route performance detection to obtain the current transmission delay rate of the power-line network 13A and of the Wi-Fi network 13B, wherein the route performance detection can be carried out through any of the following processes:

(1) Immediate detection: The network connection device 11 sends a test packet to each of the power-line network 13A and the Wi-Fi network 13B at once and determines the current transmission delay rate and the current remaining bandwidth of the power-line network 13A and of the Wi-Fi network 13B according to their respective feedbacks. The delay rates and bandwidths thus obtained will be used as reference values.

(2) Periodic detection: The network connection device 11 sends a test packet to each of the power-line network 13A and. the Wi-Fi network 13B at a fixed interval (e.g., every one hour) or at fixed time points (e.g., at 8 am, noon, and 10 pm) so as to obtain the transmission delay rate of the power-line network 13A and of the Wi-Fi network 13B at each test time. When the network connection device 11 receives a subsequent network packet, the transmission delay rates corresponding to the test time closest to the current time period or the transmission delay rates corresponding to the plural test times closest to the current time period, will be used as reference values.

(3) Historical data: As in periodic detection, the network connection device 11 sends a test packet to each of the power-line network 13A and the Wi-Fi network 13B at a fixed interval (e.g., every one hour) or at fixed time points (e.g., at 8 am, noon, and 10 pm) so as to obtain the transmission delay rate of the power-line network 13 A and of the Wi-Fi network 13B at each test time. The test data are recorded by the network connection device 11. When the network connection device 11 receives a subsequent network packet, the transmission delay rates corresponding to the same time period in a previous time frame (e.g., yesterday or last week) as the current time period will be used as reference values.

Through any of the route performance detection processes described above, the network connection device 11 can determine the difference of transmission delay rate between the power-line network 13A and the Wi-Fi network 13B.

Referring to FIG. 1, the network connection device 11 not only performs the foregoing route performance detection, but also determines, according to the type, transmission protocol, or packet source of the network packet received, whether the network packet is highly sensitive to transmission delay or whether the network packet has a re-transmission mechanism. The determination process is detailed as follows.

To carry out the determination process based on the type of the network packet, referring to FIG. 1, the network connection device 11 reads the Quality of Service (QoS) level of the network packet. When the QoS level of the network packet is Data or Background, the network connection device 11 determines that the network packet is not highly sensitive to transmission delay, meaning that even if it takes a relatively long time to transmit the network packet to the electronic device 12 or the Internet 2, the user's need to use the desired network (e.g., to surf web pages) can still be satisfied, without a poor user experience being created. In that case, therefore, the network connection device 11 chooses from the power-line network 13A and the Wi-Fi network 13B the heterogeneous network with the higher transmission delay rate as the route through which to transmit the network packet to the Internet 2 or the electronic device 12. When the QoS level of the network packet is Video, VoIP, or Internet Management, the network connection device 11 determines that the network packet is highly sensitive to transmission delay, meaning that inconvenience (e.g., delays in voice communication or lag of online streaming videos) will be caused to the user if it takes a relatively long time to transmit the network packet to the electronic device 12 or the Internet 2. In that case, therefore, the network connection device 11 chooses from the power-line network 13A and the Wi-Fi network 13B the heterogeneous network with the lower transmission delay rate as the route through which to transmit the network packet to the Internet 2 or the electronic device 12.

To carry out the determination process based on the transmission protocol, referring again to FIG. 1, the network connection device 11 determines whether the transmission protocol of the network packet is TCP (Transmission Control Protocol) or UDP (User Datagram Protocol) upon receiving the network packet. When the transmission protocol of the network packet is TCP, the network packet requires data verification during transmission to ensure data accuracy, so transmission will take a relatively long time. (That is to say, a relatively long transmission time is acceptable to a network packet using TCP.) Therefore, the network connection device 11 chooses from the power-line network 13A and the Wi-Fi network 13B the heterogeneous network with the higher transmission delay rate as the route through which to transmit the network packet to the Internet 2 or the electronic device 12. When the transmission protocol of the network packet is UDP, the network packet does not require data verification during transmission and in consequence has a relatively short transmission time. (Streaming media, for example, typically use UDP.) Therefore, the network connection device 11 chooses from the power-line network 13A and the Wi-Fi network 13B the heterogeneous network with the lower transmission delay rate as the route through which to transmit the network packet to the Internet 2 or the electronic device 12.

To carry out the determination process based on the packet source, referring to FIG. 1, the network connection device 11 determines the source website of the network packet upon receiving the network packet. If the source of the network packet is an audio/video website such as YouTube, hulu, and youku, the network packet may be an audio/video packet of a video or a piece of music, whose playback smoothness is very important to the user. In other words, if the network packet comes from an audio/video website, chances are the network packet is highly sensitive to transmission delay or uses UDP as the transmission protocol. Therefore, upon determining that the source website of the network packet is a website providing audio/video, VoIP, or like services which must be processed immediately, the network connection device 11 chooses from the power-line network 13A and the Wi-Fi network 13B the heterogeneous network with the lower transmission delay rate as the route through which to transmit the network packet to the Internet 2 or the electronic device 12, thereby ensuring smoothness of the desired service. If the source website of the network packet is determined otherwise, the network connection device 11 will choose from the power-line network 13A and the Wi-Fi network 13B the heterogeneous network with the higher transmission delay rate as the route through which to transmit the network packet to the Internet 2 or the electronic device 12.

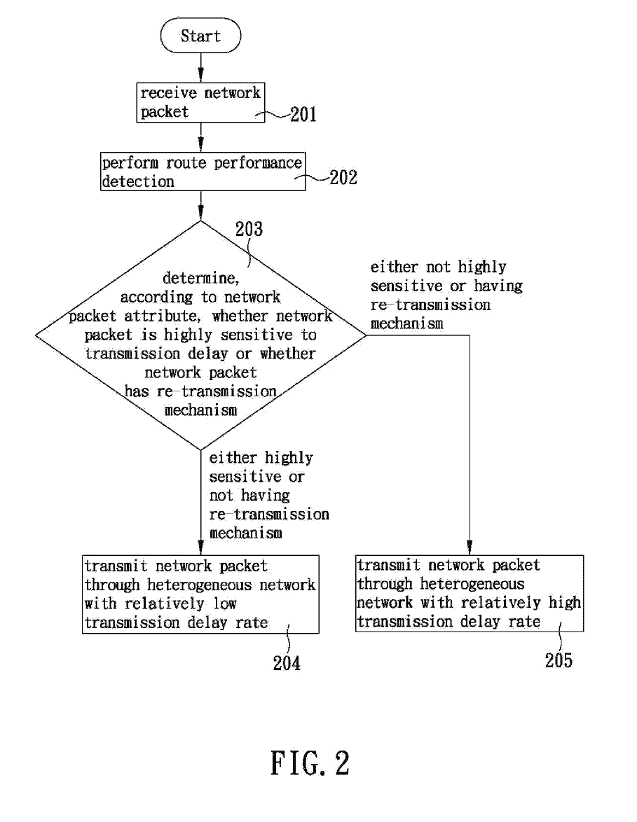

To clearly disclose the route selection method in the foregoing embodiment, the major processing steps of the network connection device 11 of the present invention are described in detail below with reference to FIG. 1 and FIG. 2:

(201) receiving a network packet from the electronic device 12 or the Internet 2, and then performing step (202);

(202) performing route performance detection to obtain the current transmission delay rate of each heterogeneous network, and then performing step (203);

(203) determining, according to the type, transmission protocol, or packet source of the network packet, whether the network packet is highly sensitive to transmission delay or whether the network packet has a re-transmission mechanism, and then performing step (204) if the network packet is highly sensitive or does not have a re-transmission mechanism and step (205) if otherwise;

(204) transmitting the network packet to the Internet 2 or the electronic device 12 through one of the heterogeneous networks that has a relatively low transmission delay rate; and

(205) transmitting the network packet to the Internet 2 or the electronic device 12 through one of the heterogeneous networks that has a relatively high transmission delay rate.

With the route selection method described above, the optimal transmission routes can be selected from among the available heterogeneous networks according to the network structure of the country or local environment where the user is. Moreover, network packets will be transmitted in accordance with their attributes to prevent ordinary Data or Background network packets from occupying those heterogeneous networks with relatively high transmission quality. This effectively increases the transmission quality and efficiency of network packets and helps provide the user with a better network experience.

Apart from transmission delay, an insufficient bandwidth also compromises the quality of network services provided through a heterogeneous network. Therefore, if the power-line network 13A in the embodiment shown in FIG. 1 is the heterogeneous network having the lower transmission delay rate, the network connection device 11 will detect the bandwidth of the power-line network 13A after transmitting the network packet. When the detection result shows that the bandwidth of the power-line network 13A becomes less than a threshold value, the network connection device 11 will transmit subsequently received network packets via the Wi-Fi network 13B instead to maintain good, network service quality. In other words, once the bandwidth of the heterogeneous network currently used for network packet transmission (e.g., the power-line network 13A) is insufficient, subsequently received, network packets will be rapidly directed, to another heterogeneous network (e.g., the Wi-Fi network 13B) so as not to lower the transmission quality of those subsequently received network packets.

While the invention herein disclosed has been described by means of specific embodiments, numerous modifications and variations could be made thereto by those skilled in the art without departing from the scope of the invention set forth in the claims.

What is claimed is:

1. A route selection method for use where a plurality of heterogeneous networks are available, the route selection method being applicable to a network connection device capable of receiving or transmitting a network packet through at least two heterogeneous networks, the route selection method comprising the steps, to be performed by the network connection device, of:
receiving the network packet;
performing route performance detection to obtain a current transmission delay rate of each said heterogeneous network;
determining, according to an attribute of the network packet, whether the network packet is highly sensitive to transmission delay or whether the network packet has a re-transmission mechanism; and
transmitting the network packet through a said heterogeneous network having a relatively low transmission delay rate, if it is determined that the network packet is highly sensitive to transmission delay or does not have the re-transmission mechanism; or through a said heterogeneous network having a relatively high transmission delay rate, if it is determined that the network packet is not highly sensitive to transmission delay or has the re-transmission mechanism.

2. The route selection method of claim 1, further comprising the steps, to be performed by the network connection device after transmitting the network packet, of: detecting a bandwidth of the heterogeneous network through which the network packet has just been transmitted; and transmitting a subsequently received network packet through another said heterogeneous network if it is determined that the bandwidth is less than a threshold value.

3. The route selection method of claim 1, wherein the route performance detection is performed through an immediate detection process comprising the steps of: sending a test packet to each said heterogeneous network immediately; and obtaining from test data respectively fed back from the at least two heterogeneous networks the current transmission delay rate and a current remaining bandwidth of each said heterogeneous network as reference values.

4. The route selection method of claim 2, wherein the route performance detection is performed through an immediate detection process comprising the steps of: sending a test packet to each said heterogeneous network immediately; and obtaining from test data respectively fed back from the at least two heterogeneous networks the current transmission delay rate and a current remaining bandwidth of each said heterogeneous network as reference values.

5. The route selection method of claim 1, wherein the route performance detection is performed through a periodic detection process comprising the steps of: sending a test packet to each said heterogeneous network at a predetermined interval or at fixed time points; and obtaining from test data respectively fed back from the at least two heterogeneous networks a transmission delay rate of each said heterogeneous network at each test time so that, upon receiving a subsequent network packet, said transmission delay rates corresponding to either a said test time closest to a current time period or plural said test times closest to the current time period are used as reference values.

6. The route selection method of claim 2, wherein the route performance detection is performed through a periodic detection process comprising the steps of: sending a test packet to each said heterogeneous network at a predetermined interval or at fixed time points; and obtaining from test data respectively fed back from the at least two heterogeneous networks a transmission delay rate of each said heterogeneous network at each test time so that, upon receiving a subsequent network packet, said transmission delay rates corresponding to either a said test time closest to a current time period or plural said test times closest to the current time period are used as reference values.

7. The route selection method of claim 1, wherein the route performance detection is performed through a historical-data process comprising the steps of: sending a test packet to each said heterogeneous network at a predetermined interval or at fixed time points; and recording test data respectively fed. back from the at least two heterogeneous networks so that, upon receiving a subsequent network packet, transmission delay rates corresponding to a same time period in a previous time frame as a current time period are used, as reference values.

8. The route selection method of claim 2, wherein the route performance detection is performed through a historical-data process comprising the steps of: sending a test packet to each said heterogeneous network at a predetermined interval or at fixed time points; and recording test data respectively fed back from the at least two heterogeneous networks so that, upon receiving a subsequent network packet, transmission delay rates corresponding to a same time period in a previous time frame as a current time period are used as reference values.

9. The route selection method of claim 1, wherein the attribute of the network packet is a type of the network packet.

10. The route selection method of claim 2, wherein the attribute of the network packet is a type of the network packet.

11. The route selection method of claim 1, wherein the attribute of the network packet is a transmission protocol of the network packet.

12. The route selection method of claim 2, wherein the attribute of the network packet is a transmission protocol of the network packet.

13. The route selection method of claim 1, wherein the attribute of the network packet is a packet source of the network packet.

14. The route selection method of claim 2, wherein the attribute of the network packet is a packet source of the network packet.

15. The route selection method of claim 1, wherein each said heterogeneous network is an Ethernet, a power-line network, a coaxial-cable network, or a wireless network.

16. The route selection method of claim 2, wherein each said heterogeneous network is an Ethernet, a power-line network, a coaxial-cable network, or a wireless network.
